(19) United States
(12) Patent Application Publication
(10) Pub. No.: US 2002/0085208 A1
(43) Pub. Date: Jul. 4, 2002

(54) Interferometer system and interferometric method

(76) Inventors: Christoph Hauger, Aalen (DE); Werner Poltinger, Oberkochen (DE); Bernd Geh, Aalen (DE); Beate Moller, Kleinpurschutz (DE)

Correspondence Address: ROSENTHAL & OSHA L.L.P., 1221 MCKINNEY AVENUE, SUITE 2800, HOUSTON, TX, 77010, US

(21) Appl. No.: 09/934,187

(22) Filed: Aug. 21, 2001

(30) Foreign Application Priority Data
Aug. 22, 2000 (DE) 100 41 041.3

(51) Int. Cl. G01B 9/02

(52) U.S. Cl. 356/479

(57) ABSTRACT

An interferometer system is disclosed. The system includes a radiation source for emitting radiation of a predetermined coherence length. The system also includes a device for splitting a beam emitted from the radiation source into a first partial beam and a second partial beam, and for subsequent superposition of the two partial beams, wherein optical path lengths of the two partial beams differ by a predetermined length difference (d1) between splitting and superposition, which length difference is greater than the coherence length. The system also includes a beam transmitting arrangement for directing the superimposed partial beams towards two optically effective, especially partially reflecting structures which are disposed at a distance (d2) from each other, wherein a first of the two structures is provided by the beam transmitting arrangement.

### CROSS-REFERENCE TO RELATED APPLICATIONS

This application claims priority from German Application Number 100-41-041.3 filed on Aug. 22, 2000.

### BACKGROUND OF INVENTION

1. Field of the Invention

The invention relates generally to an interferometer system and an interferometric method which work according to the so-called optical coherence interferometry or white-light interferometry.

2. Background Art

In optical coherence interferometry “white light” is used, i.e. light having a comparatively short coherence length. The coherence length of an optical signal is a length in which a phase correlation of the optical signal exists. For a source with great coherence length, such as a helium neon laser, this length can amount to several kilometers, whereas for a broadband white light source, such as sunlight, it amounts to only a few micrometers. For sources with such short coherence length optical interference between split and subsequently superimposed beams exists only if the optical path lengths of the two beams between their splitting and superposition correspond within some optical wavelengths.

A reflectometer working according to the principle of optical coherence interferometry is described in an article by Harry Chou et al, Hewlett Packard Journal, February 1993, pages 52-59. In this article there is also illustrated a model for the understanding of optical coherence interferometry, according to which one can imagine a source with short coherence length as a source which continuously emits “coherent wave packages” which propagate through the optical system like optical pulses. The length or the width, respectively, of these wave packages in the direction of propagation is equal to the coherence length of the source. If such a wave package is split by a beam splitter into two partial beams or two partial wave packages, respectively, and if then the two partial wave packages travel different routes, their subsequent superposition then leads to a measuring signal increased by interference, when the optical path lengths between splitting and subsequent superposition are equal within an accuracy which corresponds to the length of the wave packages.

U.S. Pat. No. 5,493,109, issued to Wei et al, teaches an ophthalmological surgical microscope which is combined with an optical coherence tomography (OCT) apparatus. Such a surgical microscope is used in surgeries in which incisions are made in the cornea of an eye in order to correct an eyesight deficiency. The required information on the actual cornea curvature is obtained by means of the tomography device.

This conventional tomography apparatus is illustrated in prior art FIG. 1. It comprises a white-light radiation source 220. The radiation emitted by the source is coupled into an optical fiber 230 and split into two partial beams by means of a beam coupler 240. The partial beams are guided in optical fibers 250 and 270, respectively. The partial beam of fiber 270 is outputted towards a reference mirror 290 by a lens 280, whereas the partial beam of fiber 250 is supplied to a transverse scanning mechanism 260 which transmits the radiation to the object to be measured, namely the cornea of an eye 255. The radiation reflected back from the object is coupled back into fiber 250, while the radiation reflected back from mirror 290 is coupled back into fiber 270. By means of beam coupler 240 the radiation in fiber 250 reflected back from the object and the radiation in fiber 270 reflected back from reference mirror 290 are superimposed and coupled into another optical fiber 265. The superimposed radiation is supplied by fiber 265 to a photodetector 275. The output of the photodetector is demodulated by a demodulator 285 and is converted by an analog-to-digital converter 295 into a form suitable for analysis by a computer 210.

Detector 275, which receives the partial beams reflected back from the object and from mirror 290, then detects the signal increased by interference when the optical path lengths of the two partial beams between their splitting at beam coupler 240 and their recombination at the beam coupler 240 are equal within the coherence length of the coherence light source.

In order to achieve equal path lengths, reference mirror 290 is displaceable in a direction shown by an arrow 291. By means of the transverse scanning mechanism 160 the location at which the first partial beam impinges on the object can be displaced transversely to the beam direction. The measurement of the curvature of the object is possible by detecting the interference signal dependent upon a change of the mirror position.

The achievable measuring accuracy is restricted, among other things, by environmental influences, such as variations in temperature and vibrations and sagging or deflections of the optical fibers, which have different influence on the optical path lengths of the two partial beams.

The article “In Vivo Optical Tomography in Ophthalmology” by A. F. Fercher, C. K. Hitzenberger, W. Drexler and G. Kamp teaches an arrangement which also works according to the principle of optical coherence interferometry and which is provided for measuring the distance between the cornea and the retina of an eye. In this known arrangement the beam of a white-light source is split into two partial branches by means of a semi-transparent mirror disposed at an angle of 45° relative to the initial beam direction. The partial branches of the beam are each retroreflected by mirrors and are again superimposed by the semi-transparent mirror to form a common beam (Michelson arrangement). One of the mirrors is displaceable in the beam direction, so that predetermined differences between the optical path lengths of the two partial branches are adjustable. In the model of the coherent wave packages, two wave packages are hereby created from each of the wave packages emitted by the source after their superposition. The wave packages are spatially separated from one another and coherent with respect to each other. The distance between those wave packages is variable and determined by the difference between the optical path lengths of the two branches. The two wave packages are sent to the eye to be measured and from there are retroreflected from a first structure, namely the cornea, and a second structure, namely the retina. The retroreflected radiation is detected by a photodetector. An intensity increased by interference is detected by the detector, when the first of the two wave packages, i.e. first in the beam direction coming from the Michelson arrangement is coherently superimposed after its reflection at the retina at the location of the photodetector with the subsequent one of the wave packages after its reflection at the cornea. This superposition takes place when the optical path length difference between the two arms of the Michelson arrangement is equal to the optical path length between cornea and retina. By respective displacement of the mirror, i.e. respective adjustment of the length difference, the distance between cornea and retina can thus be determined with a resolution of approximately the coherence length of the white-light source.

This resolution has not proven to be sufficient in some cases. In certain applications, such as in ophthalmological applications, the resolution is further limited, because the eye as a living object cannot be kept completely still. Thus, the measuring precision suffers due to the independent movement relative to each other of the two structures to be measured.

### SUMMARY OF INVENTION

An interferometer system is disclosed. The system includes a radiation source for emitting radiation of a predetermined coherence length. The system also includes a device for splitting a beam emitted from the radiation source into a first partial beam and a second partial beam, and for subsequent superposition of the two partial beams, wherein optical path lengths of the two partial beams differ by a predetermined length difference (d1) between splitting and superposition, which length difference is greater than the coherence length. The system also includes a beam transmitting arrangement for directing the superimposed partial beams towards two optically effective, especially partially reflecting structures which are disposed at a distance (d2) from each other, wherein a first of the two structures is provided by the beam transmitting arrangement.

Other aspects and advantages of the invention will be apparent from the following description and the appended claims.

### BRIEF DESCRIPTION OF DRAWINGS

FIG. 1 shows a conventional prior art interferometer system,

FIG. 2 shows a schematic setup of an interferometer system according to a first embodiment of the invention,

FIG. 3 shows a schematic representation of a double wave package as it is transmitted by a beam transmitting arrangement of the interferometer system according to FIG. 2 in a direction of structures to be measured,

FIG. 4 shows a schematic representation of wave packages as they occur after reflection of the wave packages shown in FIG. 3 from two structures disposed at a distance from each other,

FIG. 5 shows an interference signal as it is detected by a detector in the embodiment shown in FIG. 2 when wave packages are superimposed,

FIG. 6 shows an interferometer system according to a second embodiment of the invention,

FIG. 7 shows an interferometer system according to a third embodiment of the invention,

FIG. 8 shows a schematic representation of wave packages as they are reflected from two emitting locations of the interferometer system according to FIG. 7, and

FIG. 9 shows a schematic representation regarding the development of an interference pattern from the radiation emitted from the two emitting locations of the interferometer system according to FIG. 7.

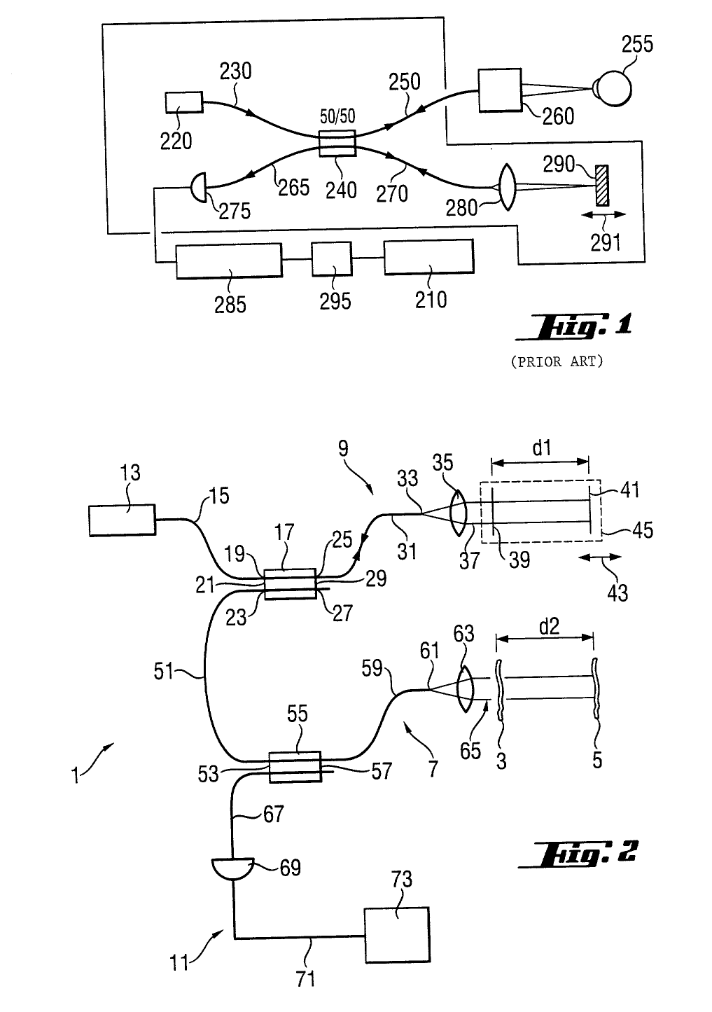

### DETAILED DESCRIPTION

The invention starts from an interferometer system comprising a light source for emitting radiation of a predetermined coherence length, a device for splitting radiation emitted from the light source into two partial beams and for the subsequent superposition of the two partial beams, as well as a beam transmitting arrangement for transmitting the superimposed partial beams to two structures disposed at a distance from each other in the beam direction. Here, the optical path lengths of the two partial beams between their splitting and subsequent superposition are different by a predetermined length difference which is greater than the coherence length. Thus, when using a white-light source, in the model of coherent wave packages, two coherent wave packages are generated by the device for splitting and superimposing which wave packages propagate in a common direction and at a predetermined distance from each other, and which are transmitted to the two structures by means of the beam transmitting arrangement.

According to a first embodiment of the invention the first of the two structures in the direction of beam propagation is provided by the beam transmitting arrangement itself. Then, the second one of the structures to be measured is formed by the object to be measured, wherein it is possible to detect the distance between the two structures, in that the length difference between the optical path lengths of the two partial beams between their splitting and their subsequent superposition is changed such that there is achieved an intensity of the radiation reflected back from the two structures, the intensity having been increased by interference.

For determining the distance between the two different structures of the object to be measured the respective distances of the two different structures from the first structure provided by the beam transmitting device are successively determined, and the difference between the two distances is detected. Here, compared to the previously explained conventional arrangement an increased measuring precision may be achievable, since, when measuring e.g. not totally stationary objects, an independent relative movement of the two structures relative to each other does not necessarily contribute to an increase of measuring errors.

According to a second embodiment of the invention, a ratio of the optical path lengths of the two partial beams between splitting and superposition is relatively small, in one embodiment less than 0.1, in another embodiment less than 0.01, and in another embodiment substantially 0.

The following thought is presented as an explanation for the setting of the optical path lengths of the two partial beams: The precision with which the distance between two structures is measurable by the interferometer system is determined by the accuracy with which the length difference between the optical path lengths is known on their routes between splitting and superposition. Since these two routes might be exposed to various environmental influences and thus unknown changes, the precision of the length difference can be increased in that the two routes together are shortened so much that one of the routes is comparatively short and particularly zero. Thus, this much shortened route can only make a minor contribution to the measuring error.

According to a third embodiment of the invention, the portions of the two partial beams reflected back from the two structures are superimposed to generate an interference pattern from the superimposed radiation.

For this purpose, the interferometer system includes beam splitting means for splitting the superimposed radiation into a third partial beam and a fourth partial beam, and separate emission means for each of these two partial beams. The locations where the third and fourth partial beams are emitted by the emission means are disposed at a predetermined distance from each other, so that the emitted third and the emitted fourth partial beam are superimposable on a screen to form an interference pattern thereon. The interference pattern is generated since locations on the screen which are not symmetrically arranged with respect to the emitting locations have different distances from the two emitting locations. Therefore, there are locations on the screen at which two wave packages are superimposed coherently, which wave packages travel with a distance from each other in the beam of the retroreflected radiation, whereas such coherent superposition is not possible at other locations of the screen. These differences in intensity bring about the detected interference pattern. From the detected interference pattern, one can then draw a conclusion about the distance of the wave packages from each other in the superimposed radiation, from which in turn the distance between the structures may be determined. In this case it is not particularly necessary that the device for splitting and superimposing makes an exact adjustment of the length difference to the distance between the two structures, in order to achieve an interferent increase in intensity of the superimposed radiation.

In another embodiment, there is provided a location-sensitive radiation detector to detect the interference pattern. In another embodiment, there is provided a determination means for determining the distance between the two structures in dependence on the detected interference pattern.

In a particularly simple manner, the interference pattern may be adequately detectable by a line detector which extends transversely to a plane of symmetry with respect to the two emitting locations.

In another embodiment, in order to increase the intensity of the radiation incident on the line detector, a structure is provided which acts as a cylinder lens and is disposed between the two emitting locations on the one hand and the line detector on the other hand.

In another embodiment, it may be advantageous to make the distance between the two emitting locations variable. When there is an increased distance between the two emitting locations, there are greater differences in the distances from the two emitting locations at a location of the screen being outside of the plane of symmetry relative to the emitting locations. As a consequence, a spatially denser interference pattern is generated on the screen. At a given size of the screen and a given distance from each other of the wave packages directed to the two structures, a greater range of detectable distances between the two structures is provided when the distance between the emitting locations is increased. Thus, at a great distance of the two emitting locations from each other, the measuring range for the two structures is increased on the one hand and, on the other hand, at a given location resolution of the detector, the measuring accuracy is reduced. At a small distance of the two emitting locations in comparison with the above, the measuring range for the distances of the two structures from each other is reduced, but the measuring accuracy in turn is increased correspondingly.

In order to be able to make a most precise determination of an unknown distance between two structures to be measured, the following method is provided: First, the distance between the two emitting locations is adjusted to a great value corresponding to a reduced measuring accuracy. Then, from the resulting interference pattern having reduced measuring accuracy the distance between the two desired structures is determined preliminarily. Subsequently, by corresponding adjustment of the length difference between the optical path lengths on the routes of the first partial beam and the second partial beam between splitting and subsequent superposition an adjustment is made such that the distance between the two wave packages corresponds to the preliminarily determined distance between the two structures to be measured. Then, the distance of the two emitting locations from each other is reduced, in order to generate an interference pattern corresponding to an increased measuring accuracy, from which pattern the distance between the two structures is then again determined with increased measuring accuracy. This can be an iterative process in that, step by step, the distance between the two wave packages is adapted more and more exactly to the distance between the structures to be measured, which distance—at increasing reduction of the distance between the two emitting locations—is determinable with ever increasing accuracy.

In another embodiment, in order to make a preliminary determination of an unknown distance between two structures, the distance between the two emitting locations is adjusted to a comparatively great value and to then continuously vary the distance between the two wave packages, i.e. the length difference between the optical path lengths of the first and the second partial beam between splitting and superposition, until the two structures to be measured generate a detectable interference pattern.

In another embodiment, when the first of the two structures is provided by the beam transmitting device itself, the precisely defined first structure may be formed by an at least partially mirrored interface between media which are of optically different densities. This can particularly be realized by an interface between glass and air at a measuring head of the interferometer system.

The measurement of the distance of the second structure from the measuring head in one embodiment takes place via the determination of the distance of a wave package reflected by the measuring head on the one hand, and a wave package reflected by the second structure on the other hand. Therefore, it is advantageous to avoid the generation of similarly distanced wave packages as interference signals at other locations of the interferometer system. It is now assumed that a preferred measuring range is predetermined for distances to be measured, namely in a way that in this measuring range comparatively exact measurements can be effected of the distance between measuring head and second structure. It is then preferred to provide a medium in the beam path upstream to the interface of the measuring head forming the first structure, which medium has a continuous, especially constant course of the diffraction index along its length in order not to generate any interference reflection there which has the same distance from the wave package reflected back from the interface, as the wave package reflected back from the structure to be measured and arranged within the measuring range.

In another embodiment of such an arrangement, the partial wave packages are transported in optical fibers, such as glass fibers, through the beam transmitting arrangement to the interface forming the first structure.

In another embodiment, a so-called GRIN lens (“Gradient Index Lens”) is coupled to the end of the glass fiber, and the exit window of the lens forms the first structure. At suitable dimensioning of the GRIN lens it can reduce the divergence of the bundle of beams exiting from a glass fiber and provide a substantially parallel emission. Simultaneously, through suitable adaptation of the diffraction indexes of glass fiber and GRIN lens and use of suitable cement material therebetween it is possible to avoid an interface which is optically effective, especially reflecting, between glass fiber and GRIN lens.

In the embodiment in which one of the two routes for the first and the second partial beams is especially short between splitting and superposition, it is possible—as explained above—to provide a particularly precise interferometer system which is stable in view of environmental influences. When using a stable interferometer system and examining the measuring signal of the coherent superposition of two wave packages, wherein the measuring signal is increased due to interference, it appears that the increased measuring signal does not merely increase continuously as a peak around its center and decrease again, the full width at half-maximum of the peak approximately corresponding to the coherence length. Rather, it shows that the measuring signal increased by interference has a fine structure with several maximum and minimum values.

Using the information about these maximum and minimum values the distance of the superimposed wave packages from each other can be determined more precisely than when the determination of the distance is made merely via a center of the continuously increasing or decreasing measured intensity which, in a manner of speaking, forms an envelope of the interference signal having several maximum and minimum values.

In another embodiment, among the maximum and minimum values occurring in the measuring signal, merely a limited number are used, which are arranged on either side adjacent one of the greatest maxima and minima of the measuring signal. In another embodiment, such a range includes less than eight coherence lengths of the source. In another embodiment, such a range includes less than four coherence lengths of the source.

The means for splitting and subsequent superimposing comprises a light path changing device for changing the length difference of the optical path lengths of the routes for the first and the second partial beam. By changing the length difference, the distance between the two wave packages of the generated double wave package can be adapted to the distance of the wave packages reflected back from the two structures, so that an interferent signal increase takes place. Knowing the length difference in the case of signal increase, a conclusion can be drawn regarding the distance between the two structures.

In another embodiment, the splitting of the beam emitted from the light source into the first and the second partial beam is effected by means of a partially reflecting mirror which is oriented substantially normal to the beam.

In this context, two embodiments are disclosed. According to a first embodiment, after superposition, the two partial beams propagate in the same direction as the radiation from the light source before entry into the device for splitting and superimposing. Thus, the device works in transmission. According to a second embodiment, the device works in reflection, the two partial beams leaving the device in a direction opposite the entry direction of the beam emitted from the light source.

In another embodiment, mirrors used for this purpose are provided at the end of a glass fiber, especially also by partially mirrored exit windows of a GRIN lens coupled to the glass fiber.

A stabilization of the interferometer system is given when the optical components which determine the optical path lengths of the first and the second partial beams between splitting and superposition, are both isolated from their environment, this isolation being preferably in view of thermal or mechanical influences, also however in view of all other possible environmental influences. Especially in combination with the embodiment in which the path for the first partial beam comprises a comparatively short optical path length, it may be sufficient to merely isolate from the environment the optical components determining the second partial beam.

The interferometer system can be used in any application where the distances between structures or a distance of a structure from a measuring head is to be determined with increased precision. Especially, also surfaces of an object or optically effective interfaces within an object can be measured in two dimensions, if the location is variable onto which the beam transmitting arrangement emits the two partial beams. For example, this can be carried out by a means which moves the object relative to the measuring head transversely to the direction of the partial beams.

The interferometer system can also be used in the manufacture of an object which has a precisely manufactured nominal surface. Here again, two embodiments of application are disclosed, namely the use in a final step of a manufacturing process of the object in the meaning of final quality control on the one hand, in which there is decided whether the manufactured surface of the object corresponds to the nominal surface of the object with the required accuracy. On the other hand, an application during the process of manufacture of the object having the nominal surface is possible in that the interferometer system is used to determine deviations of the surface from the nominal surface and, in a subsequent finishing process, to work the surface at the locations at which the deviations are too great to satisfy the precision requirements.

In another embodiment, the objects thus manufactured then have a surface which corresponds to the nominal surface with particularly great precision. The object to be manufactured may be an optical lens or a mechanical precision component.

The interferometer system can be used in eye surgery, and in the determination of the curvature of the cornea of an eye.

FIG. 2 shows a schematic functional representation of a first embodiment of an interferometer system 1 of the invention. The interferometer system 1 in the shown example serves the determination of a distance d2 between two structures 3 and 5, which have the precondition that they reflect back at least partially the radiation used for the measurement.

For this purpose, a sample branch 7 of interferometer system 1 is provided for directing the radiation to the two structures 3, 5. The determination of the distance d2 takes place via a comparison with a distance d1 which is provided in a reference branch 9 of interferometer system 1. This comparison takes place in an evaluation branch 11 of interferometer system 1 coupled to sample branch 7.

For feeding reference branch 9 interferometer system 1 includes a radiation source 13 for a radiation having a comparatively short coherence length, in order to carry out white-light interferometry with this radiation. A so-called super luminescence diode (“SLD”) has turned out to be a suitable radiation source for this purpose. The radiation emitted from super luminescence diode 13 is coupled into a glass fiber 15 which supplies the radiation to a fiber coupler 17. Fiber coupler 17 comprises a side 21 with two terminals 19 and 23. This means that radiation which enters on side 21 of fiber coupler 17 via one of the connections 19, 23 is distributed equally to terminals 25, 27 on another side 29 of the fiber coupler.

The glass fiber 15 for the supply of the radiation of SLD 13 is coupled to terminal 19 on side 21, while a glass fiber 31 of reference branch 9 is coupled to terminal 25 on the other side 29 of fiber coupler 17. The radiation from source 13 passing through fiber coupler 17 exits at an end 33 of glass fiber 31 opposite to terminal 25 and is converted into a parallel bundle of beams 37 by a lens 35. The bundle of beams 37 passes through a partially reflecting mirror 39 arranged transversely to the bundle of beams 37 and then impinges on another mirror 41 arranged parallel to mirror 39.

The two mirrors 39 and 41 form a reference standard of the interferometer system and are disposed at a distance d1 from each other. The distance d1 is variable by drive means (not shown in the drawing) for displacing mirror 41 in a direction parallel to the beam direction of the bundle of beams 37, as this is indicated in FIG. 2 by an arrow 43.

Beam 37 incident on mirror 39 is split into two partial beams by mirror 39, namely into a first partial beam which is directly reflected back from mirror 39, and a second partial beam which passes through mirror 39. The second partial beam passing through mirror 39 is finally reflected by mirror 41 disposed at distance d1 from mirror 39 and is reflected back to mirror 39, which is passed by the reflected second partial beam in a way that it is superimposed with the first partial beam directly reflected at the mirror 39. The two superimposed partial beams are focussed by lens 35 and are again coupled into the glass fiber 31 at its end 33.

As already explained above, the principle of optical coherence interferometry can be imagined in a way that the radiation source emits “coherent wave packages.” Such a wave package coupled into reference branch 9 is split into two partial wave packages 47 and 49 by means of semi-transparent mirror 39, as shown in FIG. 3. The first partial wave package 47 is directly reflected from semi-transparent mirror 39, focussed by lens 35 and coupled into glass fiber 31 at the end 33, and propagates in the glass fiber in the direction towards fiber coupler 17. FIG. 3 shows the variation in time of an intensity of radiation returning to fiber coupler 17, wherein this intensity is caused by wave packages emitted from source 13. The partial wave package 47 directly reflected back from mirror 39 passes a predetermined location of glass fiber 31 at a point in time t1. The partial wave package 49 which is not directly reflected from mirror 39, passes on through mirror 39 to mirror 41 and is reflected back therefrom to mirror 39. Package 49 then passes through mirror 39, is focussed by lens 35 and is also coupled into glass fiber 31 at end 33. Different from partial wave package 47, partial wave package 49 has thus traveled a longer path which corresponds to twice the distance d1 between mirrors 39 and 41. Accordingly, partial wave package 49 passes through the predetermined location of glass fiber 31 at a later point in time t2 which corresponds to the distance twice d1. The two partial wave packages 47, 49 together form a coherent double wave package.

Since splitting into first and second partial beams is carried out directly by mirror 39, and superposition of the two partial beams is also carried out again directly at mirror 39, it is evident that the second partial beam between splitting and superposition traveled an optical path length of twice d1, whereas the directly reflected first partial beam travels a path of length zero between splitting and superposition. The difference in lengths of the optical path lengths of the two partial beams between splitting and superposition resulting therefrom thus corresponds to exactly twice the distance between the two mirrors 39 and 41 from each other.

To achieve the particularly precise and stable adjustment of this difference in length, the two mirrors 39 and 41 are disposed within a shielding 45, shown in dashed lines in FIG. 2, which decouples the two mirrors from the environment thermally and in view of vibrations and mechanical tensions, in order to allow a stable adjustment of the difference in length. Preferably, also the drive means for changing the distance d1 between the two mirrors 39 and 41 is disposed within shielding 45.

The double wave package 47, 49 of FIG. 3 exits reference branch 9 by entering fiber coupler 17 via terminal 25. Double wave package 45, 49 exits fiber coupler 17 via terminal 23 and is coupled into a glass fiber 51 connecting reference branch 9 with sample branch 7.

Herein, glass fiber 51 is connected to one side 53 of another fiber coupler 55 such that the double wave package 47, 49 exits fiber coupler 55 again on a side 57 opposite side 53 and enters a glass fiber 59 of sample branch 7. At an end 61 of glass fiber 59 the double wave package 47, 49, and the partial beams, respectively, reflected back from the mirrors 39, 41, exit glass fiber 59, and a lens 53 forms them to be parallel bundles of partial beams 65. They are emitted towards the two structures 3 and 5 whose distance d2 from each other is to be determined. Each of the two structures 3, 5 reflects back a partial intensity of the two partial beams 65 which is focussed by lens 63 and again coupled into fiber end 61 of glass fiber 59. Speaking in the picture of the coherent wave packages there is a reflection of a partial intensity of wave packages 47, 49 from structure 3 as well as from structure 5, and these partial intensities are finally coupled into fiber 59.

FIG. 4 shows the corresponding resulting time dependent intensities at a predetermined location of glass fiber 59. Due to the distance between the two reflecting structures 3 and 5, four wave packages 47′, 47″, 49′ and 49″ coherent with each other are generated from the original double wave package 47, 49. Wave package 47′ results from the reflection of wave package 47 of FIG. 3 at structure 3 and passes through the predetermined location of glass fiber 59 at the point in time t3. Contrary thereto, the portion of wave package 47 reflected at structure 5 had to travel a path whose length is twice the distance d2 of the two structures 3 and 5 from each other. This wave package follows wave package 47′ as wave package 47″ at a correspondingly later point in time t4. Similarly, wave package 49′ is shown in FIG. 4 which represents the portion of wave package 49 of FIG. 3 reflected at the first structure 3, wherein the distance between wave packages 47′ and 49′ continues to correspond to the distance of twice d1. Wave package 49″ represents the portion of wave package 49 reflected at the second structure 5, the distance between wave packages 47″ and 49″ also being twice d1. FIG. 4 shows a situation where the distance d2 between the two structures 3 and 5 is less than the distance d1 between the two mirrors 39 and 41 of reference branch 9.

The radiation reflected back from structures 3 and 5 is coupled into fiber coupler 55 again via glass fiber 49 on side 57, exits coupler 55 on side 53 thereof and is supplied to a photodetector 69 by means of a glass fiber 67. Photodetector 69 detects the intensity of the radiation supplied thereto and outputs a measuring signal 71 corresponding to the intensity. The measuring signal is supplied to a determination means 73 for determining the distance d2 between structures 3 and 5.

The determination means 73 also controls the drive means for changing the distance d1 between the two mirrors 39 and 41 in reference branch 9 of the interferometer system.

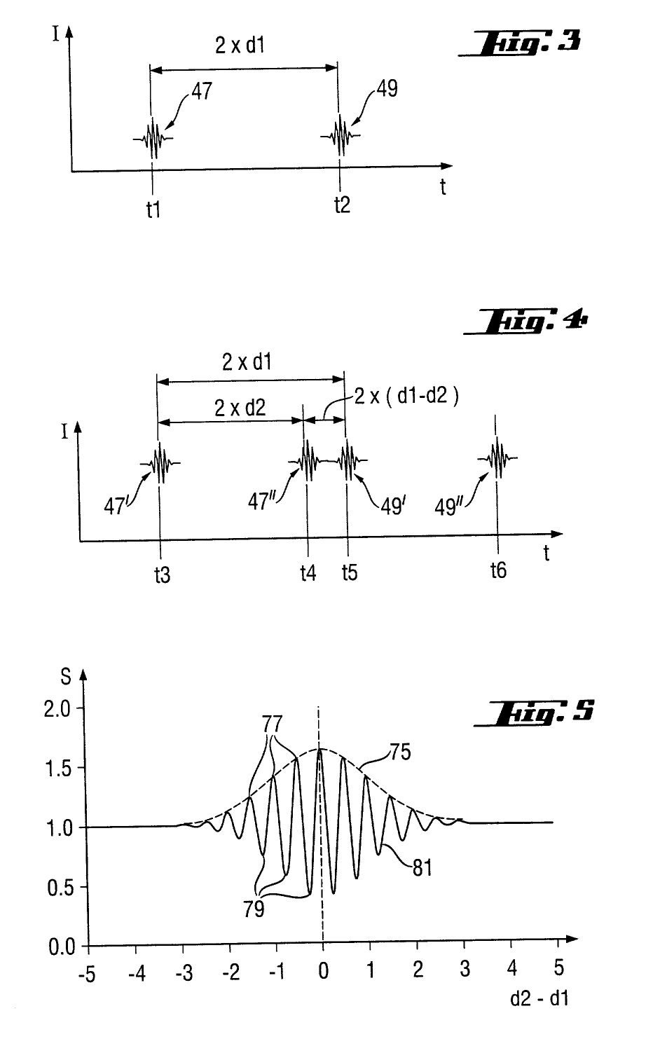

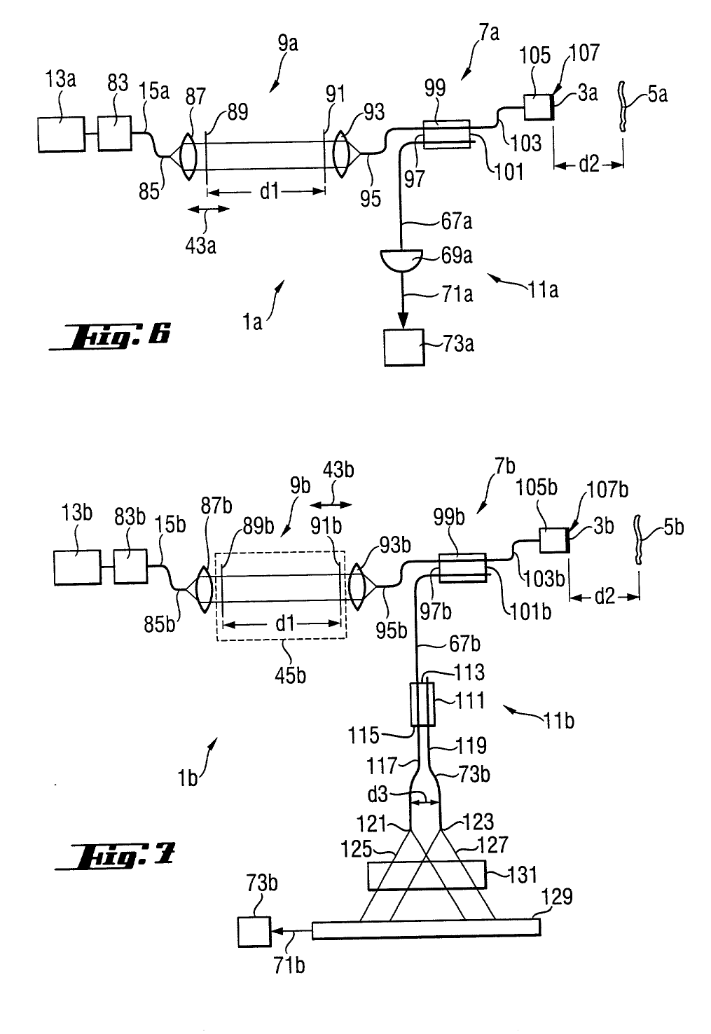

FIG. 5 shows graphically in arbitrary units an intensity S of the measuring signal 71 dependent upon a difference between distances d2 and d1.

In the situation shown in FIG. 4 where distances d1 and d2 are substantially different from each other, detector 69 supplies a signal having the strength 1.0.

If now by activating the drive means of mirror 41 the distance d1 is approximated to the distance d2, there is an overlap of the two wave packages 47″ and 49′ (compare FIG. 4), and the signal strength S increases to a maximum value at exact correspondence of the distances d2 and d1. If mirror 41 is then moved further in this direction, signal strength S decreases again. This development of the signal strength is shown in FIG. 5 by dashed line 75. By analyzing measuring points of signal 71 which form line 75, determination means 37 can determine the location of the maximum of line 75. A full width at half maximum of line 75 is within the same order of magnitude as the coherence length of radiation source 13. The location of the maximum of line 75 determines the distance d1 between the two mirrors 39 and 41 in reference branch 9 from each other, which is equal to distance d2 of the two structures 3 and 5 to be measured in sample branch 7.

In a more detailed and high-resolution evaluation of signal strength S it turns out that the measuring signal does not continuously increase from the value 1.0 up to the maximum and then decreases again, but that oscillations of the signal strength S occur having several maxima 77 and minima 79, as this is shown in FIG. 5 by solid line 81. In a way, the previously described line 75 represents an envelope of the precisely measured line 81. If for the determination of distance d2 the information on the measuring points lying on the line 81 is used with several maxima 77 and minima 79, a much more precise adjustment of the distance d1 to the value which is equal to distance d2 is possible. This analysis could be termed “interferometric evaluation” of measuring signal 71.

A relatively exact determination of the zero point of FIG. 5 is possible, for example, purely in that the zero point is centered between the two lowest minima 79 of line 81. Under inclusion of further minima adjacent on both sides for the determination of the zero point, the accuracy can be further increased. Further, the calculation rules described in the article “Electronically Scanned White-Light Interferometry: A novel Noise-Resistant Signal Processing” by R. Dändliker et al, Optics Letters Vol. 47, No. 9, May 1, 1992, pages 679-681, can be used for the still more precise determination of the zero point of FIG. 5.

Subsequently, variants of the previously described embodiments of the invention are explained. Components which correspond in view of structure and function are given with the reference numerals used for FIGS. 2, 3, 4 and 5, for distinction, however, a letter is added. For explanation, reference is made to the entire preceding description.

In FIG. 6 a variant of the embodiment of FIG. 2 is shown which differs therefrom in that the device for splitting and subsequent superimposing of the beam coming from a radiation source 13a does not work in reflection but in transmission.

Further, the interferometer system shown in FIG. 6 comprises an optical insulator 83 which protects radiation source 13a from radiation which could be reflected back into the radiation source by components of the interferometer system 1a.

The radiation emitted from radiation source 13a thus first passes through the optical insulator 83 and is inputted in a glass fiber 15a which supplies the radiation to a reference branch 9a of the interferometer system 1a. At an end 85 of glass fiber 15a the radiation exits, is parallellized by a lens 87, passes through a partially reflecting mirror 89 and impinges on another also partially reflecting semi-transparent mirror 91 which is disposed at a distance d1 from mirror 89. At mirror 91 a splitting into two partial beams takes place, namely a first parial beam which directly passes through mirror 91, and a second partial beam which is reflected back towards the mirror 89 and reflected back therefrom again towards mirror 91. The second partial beam then passes through mirror 91 and is superimposed with the directly transmitted first partial beam. Compared to the first partial beam the second partial beam has traveled a longer distance which corresponds to twice the distance d1, similar to the embodiment of FIG. 2. Also in this case, distance d1 is variable by a drive means which is not shown in the figure, which, as is indicated in FIG. 6 by arrow 43a, displaces mirror 89. A coherent wave package emitted from source 13a is thus split by the two mirrors 89 and 91 into two partial wave packages coherent with each other and at a time interval from each other which corresponds to the distance of twice d1 (compare FIG. 3).

After passing the two mirrors 89 and 91, the two partial beams are focussed by a lens 93 and coupled into another glass fiber 95 which supplies the two partial beams to a sample branch 7a of the interferometer system 1a. For this purpose, glass fiber 95 supplies the partial beams to a side 97 of a fiber coupler 99, and on another side 101 thereof they enter a glass fiber 103. A GRIN lens 105 is coupled to the end of fiber 103 such that the diffraction index of the medium penetrated by the two partial beams changes only steadily. An exit window 107 of GRIN lens 105 is made to be partially reflecting in order to form a first reflecting structure 3a. The partial beams supplied to the GRIN lens 105 for one part are reflected back into glass fiber 103 from the first structure 3a and for the other part are directed to a second structure 5a. At the second structure 5a, the radiation is at least partially reflected back into measuring head 105 and glass fiber 103. It is the task of interferometer system 1a to determine a distance d2 between second structure 5a and first structure 3a of measuring head 105.

The radiation reflected back from the exit window of GRIN lens 3a and from second structure 5a is again supplied to fiber coupler 99 via glass fiber 103 on the side 109 of the coupler and exits on the other side 97 thereof through a glass fiber 67a towards a photodetector 69a. Detector 69a detects the intensity of the radiation supplied thereto and outputs a measuring signal 71a corresponding to this intensity. The measuring signal 71a is supplied to determination means 73a for determining the distance d2. Determination means 73a may function in a similar manner as the determination means described in connection with the embodiment of FIG. 2. In the embodiment shown in FIG. 6, the wave packages supplied to sample branch 7a also have a structure as shown in FIG. 3 as double wave package with a distance of twice the distance d1 between the mirrors 89 and 91. The wave packages supplied to detector 69a further have a structure as shown in FIG. 4 when distance d2 between structure 5a and exit window 107 of the measuring head is less than the distance d1. Accordingly, the determination means 73a causes the displacement of the mirror 89 in direction 43a in order to collect the measuring curve 75 or 81 shown in FIG. 5, from which that distance d1 can be determined which is equal to the distance d2.

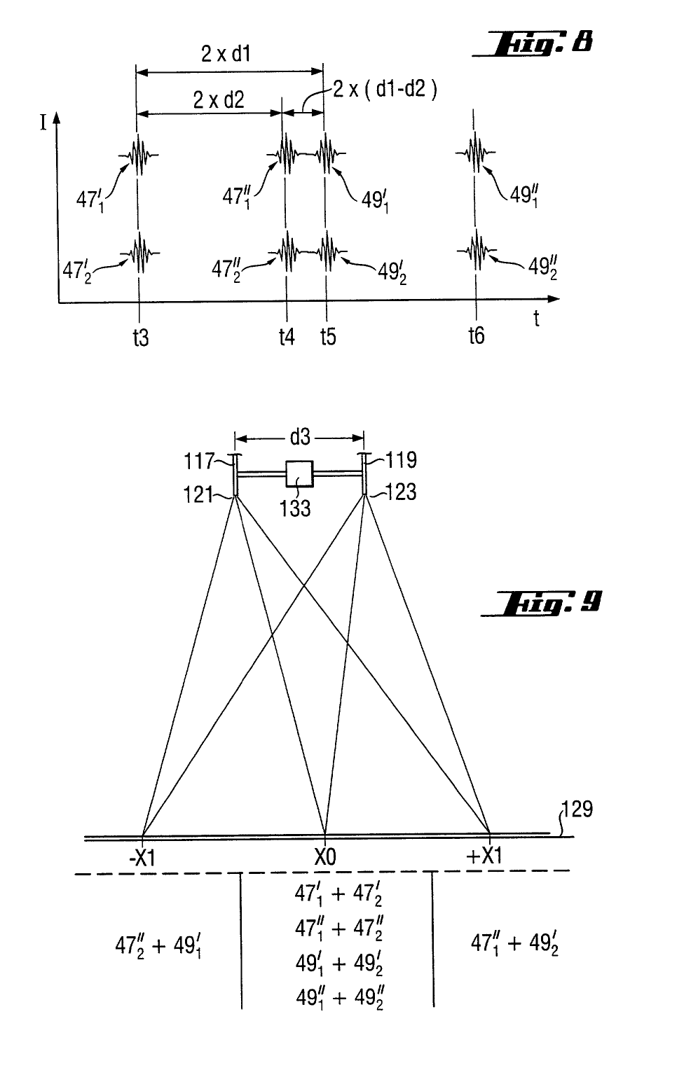

An interferometer system 1b shown in FIG. 7 has substantially the same structure with regard to its reference branch 9b and its sample branch 7b as the interferometer system shown in FIG. 6. A mirror 91b at which radiation emitted from a radiation source 13b is split into a first and a second partial beam, is displaceable in direction 43b, in order to change a distance d1 which determines the distance between the double wave package 47, 49 (compare FIG. 3). Further, mirror 89b arranged at a distance d1 from displaceable mirror 91b is in fixed arrangement with reference to the interferometer system for reflection of the second partial beam.

The substantial difference between the interferometer system 1b and the system shown in FIG. 6 is in the manner in which the radiation reflected from a measuring head 105b and the structure 5b to be measured is detected.

The retroreflected wave packages in fiber 103b or in fiber 67b show a time sequence, similar to the previously described embodiments, as it is shown in FIG. 4. However, contrary to the embodiment of FIG. 2 or the embodiment of FIG. 6, fiber 67b is not supplied directly to a photodetector but to a further 50/50 fiber coupler 111 at an input side 113 thereof. The intensities of the wave packages entering fiber coupler 111 are distributed equally to two glass fibers 117 and 119 connected to its other side 115. From there the wave packages propagate to fiber ends 121 and 123, respectively, maintaining the time sequence shown in FIG. 4. Fiber ends 121, 123 form emitting locations from which the wave packages transmitted in glass fibers 117, 119 are emitted as radiation bundles 125 and 127.

Radiation bundles 125, 127 are made to superimpose on a location-sensitive line detector 129. Line detector 129 extends parallel to a connecting line between the emitting locations 121, 123. A deflecting arrangement 131 is effective as a cylinder lens being arranged between fiber ends 121 and 123 on the one hand and line detector 129 on the other hand, in order to increase the intensity impinging on the line detector 129.

In FIG. 9 the fiber ends and emitting locations 121, 123 of the two glass fibers 117 and 119 are shown enlarged. A drive means 133 is provided which keeps fiber ends 121 and 123 at a variable distance d3 from each other.

Since the wave packages in fiber 67b are supplied to fiber coupler 111 in the time sequence shown in FIG. 4, fiber coupler 111 transmits this time sequence also into fibers 117 and 119, so that from both emitting locations 121, 123 wave packages having identical time sequence are emitted. In FIG. 8 the wave packages of the upper line show the time sequence for emitting location 121, and the wave packages of the lower line illustrate the time sequence for the emitting location 123. The wave packages in FIG. 8 are given the same reference numerals as in FIG. 4, for distinction of the two emitting locations, however, an index 1 is added for the designation of emitting location 121 as well as an index 2 for the designation of emitting location 123.

At a location X0 of the line detector 129 located symmetrically with respect to emitting locations 121 and 123, all of the wave packages emitted from emitting location 121 coherently superimpose with corresponding wave packages emitted from emitting location 123. Thus, wave packages 47′1 superimpose with wave package 47′2, 47″1 with 47″2, 49′1 with 49′2 and 49″1 with 49″2.

Another interference condition on line detector 129 is fulfilled at a location +X1 which has distances from emitting locations 121 and 123 which are different such that wave package 47″1 emitted from emitting location 121 at an earlier time, superimposes with wave package 49′2 emitted from emitting location 123 at a later time. Correspondingly, at a location −X1 arranged symmetrically to +X1 with respect to X0, wave package 47″2 emitted at an earlier time from emitting location 123 is superimposed coherently with wave package 49′1 emitted from emitting location 121 at a later time. At locations −X1 and +X1 line detector 129 thus registers an intensity which is increased due to interference.

The location-dependent intensities detected by line detector 129 as measuring signal 71b are supplied to determination means 73b which, at the known distance d3 of fiber ends 121, 123 from each other, determines from the detected distances between X0 and +X1 or/and X0 and −X1 or/and +X1 and −X1 the distance between wave packages 47″ and 49′. Since the distance between wave packages 47″ and 49′ depends on the difference between the distances d1 of the reference branch and d2 of the sample branch, the distance d2 of the sample branch can be detected, when the distance d1 of the reference branch is known.

If the distance between emitting locations 121 and 123 is reduced by drive means 133, the distance of locations +X1 and −X1 on line detector 129 from the location X0 arranged symmetrically with respect to fiber ends 121 and 123 increases in order to achieve an equal time of flight difference for the light propagation from the respective emitting locations to the screen 129. It is apparent that at a given length of line detector 129 and an increased distance d3 between fiber ends 121 and 123, the line detector can thus also detect greater differences between the distances d1 and d2, whereas at a reduced distance d3 of fiber ends 121 and 123 from each other, the distance d2 can be determined more precisely at a given location resolution of line detector 129.

If distance d2 is unknown, this distance is determined according to the following method: At first, fiber ends 121, 123 are disposed at a greater distance d3 from each other. Then distance d1 of the reference branch is changed continuously in the direction 43b via the drive means from small values towards great values, until on line detector 129 there appears a sufficiently high-contrast interference pattern, i.e. intensities increased by interference, at locations +X1 and −X1. From the distance of locations +X1 and −X1 from each other determination means 73b calculates the difference between the distances d1 of reference branch 9b and d2 of sample branch 7b. The calculation is performed with reduced accuracy due to the great distance d3 of emitting locations 121, 123 from each other.

Then, distance d1 of the reference branch is adapted to distance d2 which was determined with reduced accuracy, and the distance d3 between the fiber ends is reduced, so that a remaining difference between d1 and d2 may be determined with increased accuracy. From the remaining difference the distance d2 can be determined with increased accuracy, since distance d1 of reference branch 9b is known. If necessary, distance d1 can be adapted repeatedly to the repeatedly determined distance d2, in order to further increase the measuring accuracy for distance d2.

It is to be noted that the signal evaluation by means of the line detector, as in the embodiment shown in FIG. 7, can also be used for signal evaluation in the embodiments shown in FIG. 2 and FIG. 6. Conversely, also in the embodiment shown in FIG. 7 the signal evaluation can be carried out in the way shown in FIG. 2 and FIG. 6, i.e. merely with a photodetector which is not location sensitive.

Suitable radiation sources for the interferometer system include Superluminescence diodes, such as SLD-38-MP for example, which can be purchased from SUPERLUM LTD. in Moscow. Suitable GRIN lenses include a lens distributed by Newport under the product name Selfoc. Suitable optical insulator include the insulators distributed by Newport under the product names ISC, ISS, ISU, ISN or ISP, for example.

The embodiments of FIG. 6 and FIG. 7 each measure the distance d2 between a measuring head of the interferometer system and a structure 5 to be measured, whereas in the embodiment of FIG. 2 the distance d2 between two structures 3 and 5 to be measured is determined. However, the interferometer system according to FIG. 2 can also be equipped with a measuring head, which serves as structure 3. Further distances between two or more structures arranged outside the measuring head may be determined by means of the arrangements shown in FIG. 6 and FIG. 7.

In another embodiment, the previously described interferometer systems can be supplemented by an object holder for receiving an object to be measured. The object holder and the measuring head are movable with respect to each other in a direction transversely to the beam direction, so that the respective distances d2 are determinable at adjacent locations of the object and thus two-dimensional maps of the structure to be measured can be generated.

Advantages of the invention may include one or more of the following:

To provide an interferometer system by means of which an object can be measured with greater precision;

To provide an interferometer system which is less sensitive to environmental influences; and

To provide an interferometer system which is of simple construction.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1] An interferometer system comprising:
a radiation source for emitting radiation of a predetermined coherence length;
a device for splitting a beam emitted from the radiation source into a first partial beam and a second partial beam, and for subsequent superposition of the two partial beams, wherein optical path lengths of the two partial beams differ by a predetermined length difference (d1) between splitting and superposition, which length difference is greater than the coherence length; and
a beam transmitting arrangement for directing the superimposed partial beams towards two optically effective, especially partially reflecting structures which are disposed at a distance (d2) from each other;
wherein a first of the two structures is provided by the beam transmitting arrangement.

2] The interferometer system according to claim 1, wherein the first structure is formed by a partially reflecting interface between optical media of differing density.

3] The interferometer system according to claim 1, wherein a measuring range is predetermined by a minimum and a maximum optical path length (d2) between the first and the second structures and wherein the beam transmitting arrangement in a direction of beam upstream to the first structure comprises a medium with partial beams passing therethrough, the medium having a continuous and substantially constant, development of the refraction index along its length and which extends at least over a length between two locations disposed at a distance from the first structure which distances correspond to the minimum and maximum optical path lengths of the measuring range, respectively.

4] The interferometer system according to claim 1, wherein the beam transmitting arrangement comprises a glass fiber to which a GRIN lens is coupled.

5] The interferometer system according to claim 1, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.1.

6] The interferometer system according to claim 5, further comprising a determination means for determining the distance between the two structures dependent upon the measuring signal and the length difference, wherein the determination means determines the distance dependent upon several maximum values and minimum values of the intensity, wherein the maximum and minimum values occur when changing the length difference within a range by the distance (d2) which corresponds to the length difference (d1) between the two structures.

7] The interferometer system according to claim 6, wherein the range is less than eight coherence lengths.

8] The interferometer system according to any one of claims 1 to 7, further comprising:
a beam splitter for splitting a superposition of radiation reflected back from the two structures into a third partial beam and a fourth partial beam;
a first emitter for emitting the third partial beam from a first emitting location; and
a second emitter, for emitting the fourth partial beam from a second emitting location arranged at a predetermined distance (d3) from the first emitting location such that the third and the fourth partial beams are superimposable on a screen to form an interference pattern thereon.

9] The interferometer system according to claim 8, further comprising a location-sensitive radiation detector for detecting the interference pattern.

10] The interferometer system according to claim 9, further comprising a determination means for determining the distance between the two structures in dependence on the detected interference pattern.

11] The interferometer system according to claim 10, wherein the location-sensitive radiation detector comprises a line detector extending parallel to a connecting line between the first and the second emitting location.

12] The interferometer system according to claim 11, further comprising a cylinder lens for imaging a portion of the interference pattern on the line detector, the lens being disposed between the line detector and the two emitting locations.

13] The interferometer system according to claim 8, wherein the predetermined distance (d3) between the first emitting location and the second emitting location is variable and wherein the determination means further determines the distance between the two structures in dependence on the distance (d3) between the first emitting location and the second emitting location.

14] The interferometer system according to claim 8, further comprising a light path changing device for changing the predetermined length difference (d1), and wherein the determination means determines the distance between the two structures in dependence on the length difference (d1).

15] The interferometer system according to claim 8, wherein the device for splitting and superimposing comprises a mirror substantially normal to the beam.

16] The interferometer system according to claim 8, wherein the first partial beam at least one of substantially directly passes through the device for splitting and superimposing, and is substantially directly reflected thereby.

17] The interferometer system according to claim 8, wherein the device for splitting and superimposing comprises a partially reflecting first mirror which is oriented transversely to the direction of the beam and which is provided for reflecting the second partial beam and transmitting the first partial beam, and a second mirror which is provided for reflecting the second partial beam and which is arranged with a distance from the first mirror in a direction against the beam and parallel to the first mirror.

18] The interferometer system according to claim 8, wherein the device for splitting and superimposing comprises a first partially reflecting mirror transversely orientated relative to the direction of the beam for reflecting the first partial beam and transmitting the second partial beam, and a second mirror for reflecting the second partial beam and arranged with a distance in the direction of the beam from the first mirror and parallel therewith.

19] The interferometer system according to claim 17, wherein at least one of the first and the second mirror is provided at one end of a glass fiber.

20] The interferometer system according to claim 19, wherein the mirror provided at the end of the glass fiber comprises a GRIN-lens.

21] The interferometer system according to one of claims 1 to 7, wherein the optical components which determine the optical path length of the second partial beam between splitting and superposition, are at least one of thermally and mechanically isolated from the environment.

22] A method for the determination of a distance (d2) of an optically effective, especially partly reflecting structure from a reference surface of a measuring apparatus by means of optical interferometry, the method comprising:
generating two coherent wave packages propagating at a predetermined distance (d1) from each other in a common direction;
directing the two wave packages through the reference surface onto the structure, such that the structure reflects back one partial wave package of each of the two wave packages, wherein the reference surface reflects back one partial wave package of each of the two wave packages;
superimposing the partial wave packages reflected back from the structure and from the reference surface; and
determining the distance (d2) from the superimposed partial wave packages.

23] A method for determining a distance (d2) between two optically effective, particularly partially reflecting structures which are arranged at a distance from each other, by means of optical interferometry, the method comprising:
generating two coherent wave packages propagating in a common direction at a predetermined distance (d1) from each other;
directing the two wave packages to the two structures so that each one of the two structures reflects back a partial wave package of each of the two wave packages;
receiving the reflected partial wave packages;
splitting and transmitting the partial wave packages to two emitting locations disposed at a predetermined distance (d3) from each other;
emitting the split partial wave packages from the two emitting locations such that the split partial wave packages superimpose on a location-sensitive radiation detector to form an interference pattern thereon; and
determining the distance between the two structures (d2) from the interference pattern.

24] The method according to claim 23, wherein the distance (d1) between the wave packages and the distance (d3) between the emitting locations are variable, the method further comprising:
(a) adjusting the distance (d3) between the emitting locations to a first value corresponding to a reduced measuring accuracy;
(b) preliminarily determining the distance (d2) between the two structures from the resulting interference pattern;
(c) adjusting the distance (d1) between the wave packages to a second value corresponding to the preliminarily determined distance between the two structures;
(d) reducing the distance (d3) between the emitting locations to a second value corresponding to an increased measuring accuracy; and
(e) again determining the distance (d2) between the two structures from the resulting interference pattern with increased measuring accuracy.

25] The method according to claim 24, wherein, after (e);
(b), (c), (d), and (e) are repeated by using the distance determined in (e) as the preliminarily determined distance of (b).

26] The method according to claim 24, wherein after (a) and before (b);
the distance between the wave packages is varied continuously until an interference pattern generated by the two structures can be detected.

27] The method according to any one of claims 22 to 26, wherein the method is used for eye surgery.

28] A method for providing an object having a nominal surface, comprising:
measuring a surface of the object using the method according to any one of claims 22 to 26;
determining deviations of the measured surface from the nominal surface of the object;
providing the object if the deviations are less than a predetermined threshold value; and
not providing the object if the deviations are greater than the predetermined threshold value.

29] A method for manufacturing an object having a nominal surface, comprising:
measuring a surface of the object using the method according to any one of claims 22 to 26;
determining deviations of the measured surface from the nominal surface of the object; and
removing surface regions of the object at locations where deviations are detected between measured surface and nominal surface, in order to adapt the surface of the object to the nominal surface.

30] The method according to claim 29, wherein the object to be manufactured is an optical lens.

31] The method according to claim 30, wherein the object to be manufactured is the lens of a human eye and wherein the removal of lens material serves the correction of an eyesight deficiency.

32] The interferometer system according to claim 1, wherein the first structure is formed by a partially reflecting interface between glass and air.

33] The interferometer system according to claim 2, wherein a measuring range is predetermined by a minimum and a maximum optical path length (d2) between the first and the second structures and wherein the beam transmitting arrangement in a direction of beam upstream to the first structure comprises a medium with partial beams passing therethrough, the medium having a continuous and substantially constant, development of the refraction index along its length and which extends at least over a length between two locations disposed at a distance from the first structure which distances correspond to the minimum and maximum optical path lengths of the measuring range, respectively.

34] The interferometer system according to claim 2, wherein the beam transmitting arrangement comprises a glass fiber to which a GRIN lens is coupled having an exit window providing the first structure.

35] The interferometer system according to claim 3, wherein the beam transmitting arrangement comprises a glass fiber to which a GRIN lens is coupled having an exit window providing the first structure.

36] The interferometer system according to claim 1, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.01.

37] The interferometer system according to claim 1, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is substantially zero.

38] The interferometer system according to claim 2, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.1.

39] The interferometer system according to claim 3, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.1.

40] The interferometer system according to claim 4, further comprising:
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.1.

41] The interferometer system according to claim 6, wherein the range is less than four coherence lengths.

42] The interferometer system according to claim 18, wherein at least one of the first and the second mirror is provided at one end of a glass fiber.

43] The method according to claim 25, wherein after (a) and before (b);
the distance between the wave packages is varied continuously until an interference pattern generated by the two structures can be detected.

44] An interferometer system comprising:
a radiation source for emitting radiation of a predetermined coherence length;
a device for splitting a beam emitted from the radiation source into a first partial beam and a second partial beam, and for subsequent superposition of the two partial beams, wherein optical path lengths of the two partial beams differ by a predetermined length difference (d1) between splitting and superposition, which length difference is greater than the coherence length; and
a beam transmitting arrangement for directing the superimposed partial beams towards two optically effective, especially partially reflecting structures which are disposed at a distance (d2) from each other;
an optical path changing means for changing the predetermined length difference (d1); and
a detector for receiving a superposition of radiation reflected back from both structures and for outputting a measuring signal representing an intensity of the retroreflected radiation;
wherein a ratio of the optical path length of the first partial beam between splitting and superposition thereof divided by the optical path length of the second partial beam between splitting and superposition thereof is less than 0.1.

45] An interferometer system comprising:
a radiation source for emitting radiation of a predetermined coherence length;
a device for splitting a beam emitted from the radiation source into a first partial beam and a second partial beam, and for subsequent superposition of the two partial beams, wherein optical path lengths of the two partial beams differ by a predetermined length difference (d1) between splitting and superposition, which length difference is greater than the coherence length; and
a beam transmitting arrangement for directing the superimposed partial beams towards two optically effective, especially partially reflecting structures which are disposed at a distance (d2) from each other;
a beam splitter for splitting a superposition of radiation reflected back from the two structures into a third partial beam and a fourth partial beam;
a first emitter for emitting the third partial beam from a first emitting location; and
a second emitter, for emitting the fourth partial beam from a second emitting location arranged at a predetermined distance (d3) from the first emitting location such that the third and the fourth partial beams are superimposable on a screen to form an interference pattern thereon.
